(19) United States
(12) Patent Application Publication
(10) Pub. No.: US 2026/0292457 A1
(43) Pub. Date: Sep. 24, 2026

(54) DEVICE AND METHOD OF COMMUNICATION

(71) Applicant: NEC Corporation, Tokyo (JP)

(72) Inventors: Zonghui XIE, Beijing (CN); Lin LIANG, Beijing (CN); You LI, Beijing (CN); Gang WANG, Beijing (CN)

(73) Assignee: NEC Corporation, Tokyo (JP)

(21) Appl. No.: 19/474,505

(22) PCT Filed: Apr. 11, 2023
(86) PCT No.: PCT/CN2023/087648

§ 371 Date: Oct. 10, 2025

(51) Int. Cl. H04W 4/70

(52) U.S. Cl. CPC H04W 4/70

(57) ABSTRACT

Embodiments of the present disclosure relate to devices and methods of communication. In one aspect, a first device determines whether a second device fulfills a condition for communication with an A-IoT device. If the second device fulfills the condition, the first device initiates the communication between the second device and the A-IoT device. In this way, relevant information of potential second devices may be collected and one of the potential second devices may be determined for communication with an A-IoT device.

### TECHNICAL FIELD

Embodiments of the present disclosure generally relate to the field of telecommunication, and in particular, to devices and methods of communication involving an ambient-Internet of things (A-IoT) device.

### BACKGROUND

Recently, it has been proposed to incorporate an A-IoT device into a cellular network communication. However, a solution of cellular communication involving an A-IoT device (also referred to as A-IoT communication herein) is still unclear and needs to be further developed.

### SUMMARY

In general, embodiments of the present disclosure provide methods, devices and computer storage media for A-IoT communication.

In a first aspect, there is provided a first device. The first device may be a terminal device or an access network device. The first device comprises a processor. The processor is configured to cause the first device to: determine that a second device fulfills a condition for communication with an A-IoT device; and initiate the communication between the second device and the A-IoT device.

In a second aspect, there is provided a first device. The first device may be a terminal device or an access network device. The first device comprises a processor. The processor is configured to cause the first device to: determine that an A-IoT device is to be changed from communicating with a second device to communicating with a third device; and determine a configuration associated with the change for communication between the third device and the A-IoT device.

In a third aspect, there is provided an A-IoT device. The A-IoT device comprises a processor. The processor is configured to cause the A-IoT device to: receive, from a first device, a command for A-IoT communication; and in accordance with a determination that information of the first device in the command matches a configuration of the A-IoT device, response to the command.

In a fourth aspect, there is provided an A-IoT device. The A-IoT device comprises a processor. The processor is configured to cause the A-IoT device to: receive a command associated with a change of the A-IoT device from communicating with a second device to communicating with a third device; and update, based on the command, a configuration associated with the change.

In a fifth aspect, there is provided an A-IoT device. The A-IoT device comprises a processor. The processor is configured to cause the A-IoT device to: receive a command for obtaining mobility information of the A-IoT device; and transmit the mobility information of the A-IoT device.

In a sixth aspect, there is provided a method of communication. The method comprises: determining, at a first device, that a second device fulfills a condition for communication with an A-IoT device; and initiating the communication between the second device and the A-IoT device.

In a seventh aspect, there is provided a method of communication. The method comprises: determining, at a first device, that an A-IoT device is to be changed from communicating with a second device to communicating with a third device; and determining a configuration associated with the change for communication between the third device and the A-IoT device.

In an eighth aspect, there is provided a method of communication. The method comprises: receiving, at an ambient Internet of things (A-IoT) device and from a first device, a command for A-IoT communication; and in accordance with a determination that information of the first device in the command matches a configuration of the A-IoT device, responsing to the command.

In a ninth aspect, there is provided a method of communication. The method comprises: receiving, at an A-IoT device, a command associated with a change of the A-IoT device from communicating with a second device to communicating with a third device; and updating, based on the command, a configuration associated with the change.

In a tenth aspect, there is provided a method of communication. The method comprises: receiving, at an A-IoT device, a command for obtaining mobility information of the A-IoT device; and transmitting the mobility information of the A-IoT device.

In an eleventh aspect, there is provided a computer readable medium having instructions stored thereon. The instructions, when executed on at least one processor, cause the at least one processor to perform the method according to any of the sixth to tenth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating an example function setting for A-IoT communication according to embodiments of the present disclosure;

FIG. 3A illustrates a schematic diagram illustrating an example process of initiating an A-IoT communication based on information collection according to embodiments of the present disclosure;

FIG. 3B illustrates a schematic diagram illustrating another example process of initiating an A-IoT communication based on information collection according to embodiments of the present disclosure;

FIG. 4A illustrates a schematic diagram illustrating an example process of initiating an A-IoT communication based on condition provision according to embodiments of the present disclosure;

FIG. 4B illustrates a schematic diagram illustrating another example process of initiating an A-IoT communication based on condition provision according to embodiments of the present disclosure;

FIG. 5 illustrates a schematic diagram illustrating an example reader change according to embodiments of the present disclosure;

FIG. 6 illustrates a schematic diagram illustrating an example process of determining a configuration of an A-IoT communication by an access network device according to embodiments of the present disclosure;

FIG. 7A illustrates a schematic diagram illustrating an example process of determining a configuration of an A-IoT communication by a terminal device according to embodiments of the present disclosure;

FIG. 7B illustrates a schematic diagram illustrating another example process of determining a configuration of an A-IoT communication by a terminal device according to embodiments of the present disclosure;

FIG. 8 illustrates a schematic diagram illustrating a process of updating a configuration of an A-IoT communication according to embodiments of the present disclosure;

FIG. 9 illustrates a schematic diagram illustrating a process of an A-IoT communication with access check according to embodiments of the present disclosure;

FIG. 10 illustrates a schematic diagram illustrating a process of an A-IoT communication for mobility information delivery according to embodiments of the present disclosure;

FIG. 11 illustrates an example method of communication implemented at a first device in accordance with some embodiments of the present disclosure;

FIG. 12 illustrates another example method of communication implemented at a first device in accordance with some embodiments of the present disclosure;

FIG. 13 illustrates an example method of communication implemented at an A-IoT device in accordance with some embodiments of the present disclosure;

FIG. 14 illustrates another example method of communication implemented at an A-IoT device in accordance with some embodiments of the present disclosure;

FIG. 15 illustrates still another example method of communication implemented at an A-IoT device in accordance with some embodiments of the present disclosure; and

FIG. 16 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” may refer to a core network device or an access network device. The term “core network device” refers to any device or entity that provides access and mobility management function (AMF), network exposure function (NEF), authentication server function (AUSF), unified data management (UDM), session management function (SMF), user plane function (UPF), a location management function (LMF), etc., In other embodiments, the core network device may be any other suitable device or entity providing any other suitable functionality.

As used herein, the term “access network device” refers to a device which is capable of providing or hosting a cell or coverage where terminal devices can communicate. Examples of an access network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have artificial intelligence (AI) or machine learning (M) capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “A-IoT” may be interchangeably used with “passive IoT”. The term “A-IoT device” may refer to a device comprising an energy harvesting module and a backscattering module. The A-IoT device may receive an energy supply signal or command via the energy harvesting module and backscatter a signal via the backscattering module. Some example use cases of the A-IoT device are listed below.

| High Level Function | Reference Use Cases | Brief Scenario Description |
|---|---|---|
| Inventory | Automated warehousing | Items are inventoried either at |
| | Airport terminal/shipping | specific locations or when passing |
| | port | through a gate, within a |
| | | warehouse. |
| Object finding | Finding remote lost item | Location of lost item is |
| | Personal belongings finding | determined by UEs/network. |
| Local sensor | Smart home | Reports from one or more sensors |
| reporting | Smart bridge health | located on a bridge (e.g. tilt, |
| | monitoring | vibration, water level) |
| Wide area sensor | Fresh food supply chain | Temperature and/or location |
| reporting | | reports are collected for each item |
| | | e.g. on a regular basis (in a food |
| | | distribution chain i.e. items are |
| | | not stationary) |
| Proximity detection/ | Indoor positioning in shopping | Proximity to a fixed item is used |
| positioning | center | to determine position in an indoor |
| | Museum guide | area. |
| Device state control | Smart agriculture | Network is able to control |
| | | greenhouse conditions in response |
| | | to sensors (e.g. irrigation or |
| | | ventilation) |

In the context of the present disclosure, the term “command UE” may refer to a terminal device transmitting a command to an A-IoT device to implement select, inventory or access (e.g., read and write) to the A-IoT device. The term “excitation UE” may refer to a terminal device providing an excitation signal or energy to an A-IoT device. After receiving the excitation signal, the A-IoT device may generate an induced current, and then receive information and send information through energy obtained by the induced current. It is to be understood that the names “command UE” and “excitation UE” merely are examples, and any other suitable names are also feasible.

In the context of the present disclosure, the term “reader” may refer to a device (e.g., a terminal device or an access network device) communicating with an A-IoT device. It is to be understood that the name “reader” is merely an example, and any other suitable names are also feasible.

In the context of the present disclosure, the term “mobility” may refer to a change of a reader communicating with an A-IoT device. In the context of the present disclosure, the change of the reader may refer to a change from a first reader in a set of first readers to a second reader in a set of second readers.

In the context of the present disclosure, the term “configuration associated with the change” may be interchangeably used with “mobility related configurations”. In the context of the present disclosure, the term “A-IoT procedure” may be interchangeably used with “A-IoT communication”.

Embodiments of the present disclosure provide solutions of cellular communication involving an A-IoT device. In one aspect, a first device determines whether a second device fulfills a condition for communication with an A-IoT device. If the second device fulfills the condition for communication with an A-IoT device, the first device initiates the communication between the second device and the A-IoT device. In some embodiments, the first device is a network device. In some embodiments, the first device is a terminal device. In this way, relevant information of potential second devices may be collected and one of the potential second devices may be determined for communication with an A-IoT device.

In another aspect, upon determination that an A-IoT device is to be changed from communicating with a second device to communicating with a third device, a first device determines a configuration associated with the change for communication between the third device and the A-IoT device. In some embodiments, the first device is a network device. In some embodiments, the first device is a terminal device. In this way, a change of a device communicating with an A-IoT device may be facilitated.

In another aspect, an A-IoT device receives a command for A-IoT communication from a first device. If information of the first device in the command matches a configuration of the A-IoT device, the A-IoT device responses to the command. In some embodiments, the first device is a network device. In some embodiments, the first device is a terminal device. In this way, a selective response to an A-IoT command may be achieved.

In another aspect, an A-IoT device receives a command associated with a change of the A-IoT device from communicating with a second device to communicating with a third device. Based on the command, the A-IoT device updates a configuration associated with the change. In some embodiments, the first device is a network device. In some embodiments, the first device is a terminal device. In some embodiments, the second device is a network device. In some embodiments, the second device is a terminal device. In this way, a configuration of A-IoT communication may be updated.

In another aspect, upon reception of a command for obtaining mobility information of the A-IoT device, an A-IoT device transmits the mobility information of the A-IoT device. Based on the command, the A-IoT device updates a configuration associated with the change. In this way, mobility information of an A-IoT device may be retrieved.

Principles and implementations of the present disclosure will be described in detail below with reference to the figures.

### Example of Communication Network

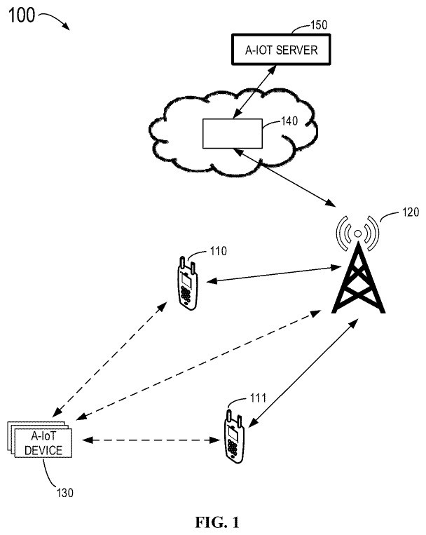

FIG. 1 illustrates a schematic diagram of an example communication network 100 in which some embodiments of the present disclosure can be implemented. As shown in FIG. 1, the communication network 100 may include terminal devices 110 and 111 and an access network device 120. In some embodiments, the access network device 120 may provide one or more serving cells (not shown) to serve the terminal devices 110 and 111.

As shown in FIG. 1, the communication network 100 may further include an A-IoT device 130. In some embodiments, the access network device 120 and the A-IoT device 130 may communicate with each other. In some embodiments, one of the terminal devices 110 and 111 and the A-IoT device 130 may communicate with each other. In some embodiments, the A-IoT device 130 may communicate with one of the terminal devices 110 and 111 in a forward link, and may communicate with the access network device 120 in a backward link. In some embodiments, the A-IoT device 130 may communicate with the access network device 120 in a forward link, and may communicate with one of the terminal devices 110 and 111 in a backward link.

As shown in FIG. 1, the communication network 100 may further include a core network device 140 and an A-IoT server 150. In some scenarios, the A-IoT device 130 may communicate with the A-IoT server 150 via a cellular network comprising the terminal device 110 and/or 111 and/or 112, and the access network device 120 and the core network device 140.

It is to be understood that the number of devices in FIG. 1 is given for the purpose of illustration without suggesting any limitations to the present disclosure. The communication network 100 may include any suitable number of access network devices and/or terminal devices and/or A-IoT devices and/or core network devices and/or A-IoT servers adapted for implementing implementations of the present disclosure.

The terminal device 110 may communicate with the access network device 120 via a Uu interface. The access network device 120 may communicate with the core network device 140 via an Ng interface. The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

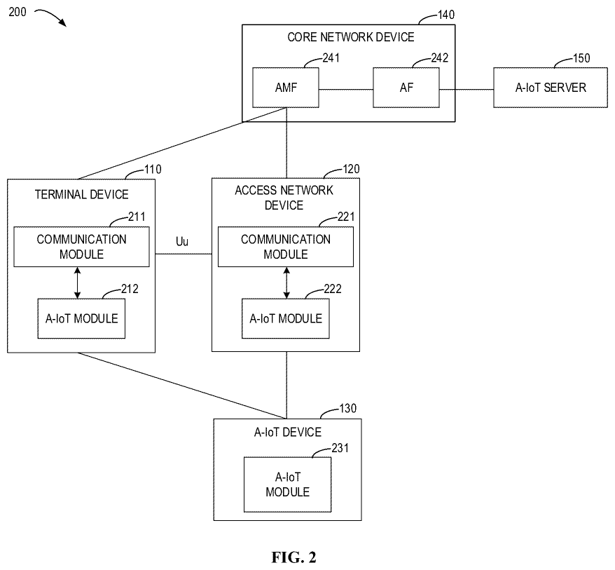

FIG. 2 illustrates a schematic diagram 200 illustrating an example function setting for A-IoT communication according to embodiments of the present disclosure. For convenience, its description will be given with reference to the terminal device 110 of FIG. 1. It is to be understood that the function setting is also suitable for the terminal devices 111 and 112.

As shown in FIG. 2, the terminal device 110 may include a communication module 211 and an A-IoT module 212. The access network device 120 may include a communication module 221 and an A-IoT module 222. The A-IoT device 130 may include an A-IoT module 231. The core network device 140 may include an access management function (AMF) 241 and an A-IoT function (AF) 242.

Each of the A-IoT modules 212 and 222 is configured to handle communications between a reader (a terminal device or an access network device) and the A-IoT device 130. In some embodiments, each of the A-IoT modules 212 and 222 may have a communication function to process a command indicating an inventory, a selection, an access or a mobility procedure. In some embodiments, each of the A-IoT modules 212 and 222 may have an energy supply function to provide excitation signal or energy for the A-IoT device 130. In some embodiments, each of the A-IoT modules 212 and 222 may have a measurement function based on an A-IoT signal. For example, each of the A-IoT modules 212 and 222 may generate a measurement report for A-IoT devices. In another example, each of the A-IoT modules 212 and 222 may input measurement results to the corresponding communication module for generation of a measurement report. So far, functions of A-IoT modules may be defined.

In some embodiments, an example function setting for the communication module 211 at the terminal device 110 may be described as at least one of the following:
Receive A-IoT related configurations from a network (NW) and delivered it to A-IoT module;
Receive A-IoT commands from NW and delivered it to A-IoT module;
Control A-IoT module to perform A-IoT signal measurement;
Perform A-IoT signal measurements independently;
Indicated A-IoT module to provide excitation signal (based on the requirements/configurations/indication from NW);
Maintain the registration/capability/authentication/authorization/context information of A-IoT devices.

In some embodiments, an example function setting for the A-IoT module 212 at the terminal device 110 may be described as at least one of the following:
Load configurations from communication module;
Perform A-IoT procedure based on the A-IoT command from communication module;
Perform A-IoT signal measurements based on indication from communication module;
Perform A-IoT signal measurements independently;
Provide excitation signal based on indication from communication module;
Provide excitation signal independently;
Maintain the registration/capability/authentication/authorization/context information of A-IoT devices.

In some embodiments, an example function setting for the A-IoT module 231 at the A-IoT device 130 may be described as at least one of the following:
Perform A-IoT procedure based on the A-IoT command from a reader;
Perform A-IoT procedure based on the energy of excitation signal.

In some embodiments, an example function setting for the communication module 221 at the access network device 120 may be described as at least one of the following:
Deliver A-IoT related configurations to UE;
Deliver A-IoT related configurations to A-IoT module;
Transmit/forward A-IoT commands to UE or A-IoT device;
Control A-IoT module to perform A-IoT signal measurement;
Perform A-IoT signal measurements independently;
Indicated A-IoT module to provide excitation signal;
Maintain the registration/capability/authentication/authorization/context information of A-IoT devices.

In some embodiments, an example function setting for the A-IoT module 222 at the access network device 120 may be described as at least one of the following:
Load configurations from communication module;
Perform A-IoT procedure based on the A-IoT command from communication module;
Perform A-IoT signal measurements based on indication from communication module;
Perform A-IoT signal measurements independently;
Provide excitation signal based on indication from communication module;
Provide excitation signal independently;
Maintain the registration/capability/authentication/authorization/context information of A-IoT devices.

So far, functions of modules in a terminal device or an access network device or an A-IoT device may be defined.

In some embodiments, a communication module (e.g., the communication module 211 or 221) may collect A-IoT function related information. In some embodiments, the communication module may deliver the collected A-IoT function related information to an A-IoT module (e.g., the A-IoT module 212 or 222) for reader determination. In some embodiments, the communication module may determine a reader based on the collected A-IoT function related information.

In some embodiments, an A-IoT module (e.g., the A-IoT module 212 or 222) may collect A-IoT function related information. In some embodiments, the A-IoT module may deliver the collected A-IoT function related information to a communication module (e.g., the communication module 211 or 221) for reader determination. In some embodiments, the A-IoT module may determine a reader based on the collected A-IoT function related information.

In some embodiments, a communication module (e.g., the communication module 211 or 221) may perform an evaluation of a condition for an A-IoT procedure or an A-IoT communication. Upon the condition is fulfilled, the communication module may indicate to an A-IoT module (e.g., the A-IoT module 212 or 222) that the condition for initiating an A-IoT procedure is fulfilled. In some embodiments, an A-IoT module (e.g., the A-IoT module 212 or 222) may perform an evaluation of a condition for an A-IoT procedure or an A-IoT communication. Upon the condition is fulfilled, the A-IoT module may indicate to a communication module (e.g., the communication module 211 or 221) that the condition for initiating an A-IoT procedure is fulfilled.

In some embodiments, a communication module (e.g., the communication module 211 or 221) may perform an evaluation of a condition for a mobility procedure. Upon the condition is fulfilled, the communication module may indicate to an A-IoT module (e.g., the A-IoT module 212 or 222) that the condition for a mobility procedure is fulfilled. In some embodiments, an A-IoT module (e.g., the A-IoT module 212 or 222) may perform an evaluation of a condition for a mobility procedure. Upon the condition is fulfilled, the A-IoT module may indicate to a communication module (e.g., the communication module 211 or 221) that the condition for initiating a mobility procedure is fulfilled.

So far, interactions between a communication module and an A-IoT module in a terminal device or a network device may be defined. It is to be understood that the following embodiments may be carried out in combination with a framework of FIG. 2.

In some scenarios, if all readers need to process an A-IoT procedure at the same time, high power consumption and low resource utilization may be caused. In some scenarios, an A-IoT device may be unable to perform measurements and thus cannot be aware of a movement relative to a reader.

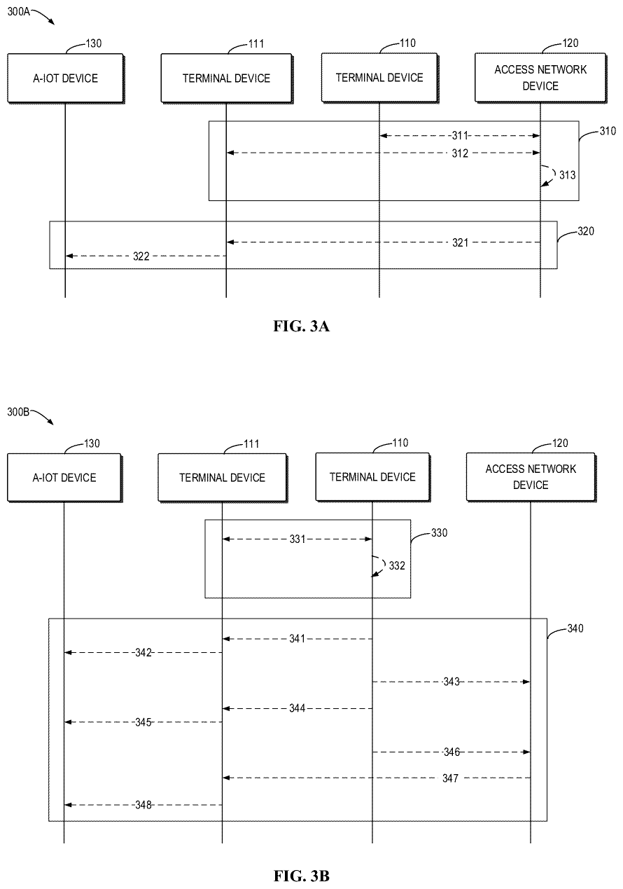

Embodiments of the present disclosure provide solutions of A-IoT communication so as to solve the above issues and other potential issues. The detailed description will be made with reference to FIGS. 3A to 10 below.

### Example Implementation of Initiating of A-IoT Communication

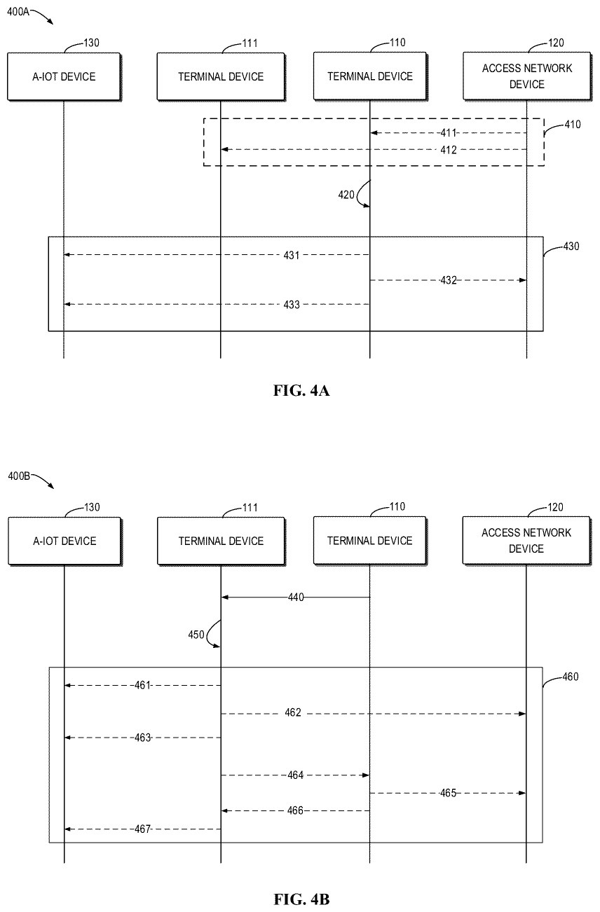

Embodiments of the present disclosure provide a solution of initiating an A-IoT communication. In the solution, if a condition for communication with an A-IoT device is fulfilled by a reader, a communication between the reader and the A-IoT device is initiated. More details will be description with reference to FIGS. 3A and 4B.

FIG. 3A illustrates a schematic diagram illustrating an example process 300A of initiating an A-IoT communication based on information collection according to embodiments of the present disclosure. For the purpose of discussion, the process 300A will be described with reference to FIG. 1. The process 300A may involve the terminal devices 110 and 111, the access network device 120 and the A-IoT device 130 as illustrated in FIG. 1. It is to be understood that the steps and the order of the steps in FIG. 3A are merely for illustration, and not for limitation. For example, the order of the steps may be changed. Some of the steps may be omitted or any other suitable additional steps may be added.

In this example, the access network device 120 determines to trigger an A-IoT communication with the A-IoT device 130 or reader selection, and the terminal devices 110 and 111 are readers. That is, the access network device 120 serves as a trigger node. In some embodiments, the triggering of the A-IoT procedure or reader selection may be indicated by the core network device 140, e.g., AMF or AF. In some embodiments, the triggering of the A-IoT procedure or reader selection may be indicated by the A-IoT server 150.

As shown in FIG. 3A, the access network device 120 determines 310 which reader fulfills a condition (i.e., a condition for an A-IoT procedure or an A-IoT communication) for communication with the A-IoT device 130. In some embodiments, the access network device 120 may obtain 311, from the terminal device 110, information (i.e., A-IoT function related information) of the terminal device 110 associated with the communication, and obtain 312, from the terminal device 111, information of the terminal device 111 associated with the communication. Based on the information of readers, the access network device 120 may determine 313 a reader (e.g., the terminal device 111) fulfilling the condition.

In some embodiments, the access network device 120 may obtain information of the terminal device 110 or 111 via a dedicated signaling. In some embodiments, the access network device 120 may obtain information of the terminal device 110 or 111 during UE capability signaling. In some embodiments, the access network device 120 may obtain information of the terminal device 110 or 111 during a registration procedure. In some embodiments, the access network device 120 may obtain information of the terminal device 110 or 111 from a core network (e.g., the core network device 140). In some embodiments, the access network device 120 may obtain information of the terminal device 110 or 111 during a measurement and report procedure.

In some embodiments, the information of the terminal device 110 or 111 may be associated with capability for the communication with the A-IoT device 130. For example, the capability may include information of whether the terminal device 110 or 111 supports an A-IoT service. In another example, the capability may include information of whether the terminal device 110 or 111 has an A-IoT signal transmitting or receiving function.

In some embodiments, the information of the terminal device 110 or 111 may be associated with an authentication or authorization status for the communication with the A-IoT device 130. For example, the authentication or authorization status may include information of whether the terminal device 110 or 111 is authenticated or authorized by a core network as a legal A-IoT reader. In some embodiments, the authentication or authorization status may be collected during an access or registration procedure.

In some embodiments, the information of the terminal device 110 or 111 may be associated with an interference level measured by the terminal device 110 or 111. In other words, it is to be determined whether the interferences caused by surrounding environment or other nearby A-IoT communications allow the communication with the A-IoT device 130. In some embodiments, the access network device 120 may transmit a measurement and report configuration to the terminal device 110 or 111. In some embodiments, the measurement may be based on an energy supply signal. In some embodiments, the measurement may be based on a trigger signal. In some embodiments, the measurement may be based on a backscatter signal. In some embodiments, the report may be performed periodically. In some embodiments, the report may be performed after a period of time. In some embodiments, the report may be performed if a predetermined condition (e.g., serving quality is below (i.e., lower than or equal to) threshold quality for a period of time) is fulfilled.

In some embodiments, the information of the terminal device 110 or 111 may be associated with a mobility status of the terminal device 110 or 111. For example, the mobility status may include low or medium or high mobility determined based on state detection criteria existing or to be developed in future. In another example, the mobility status may include a moving velocity.

In some embodiments, the information of the terminal device 110 or 111 may be associated with serving quality measured by the terminal device 110 or 111. In some embodiments, the serving quality may be quality of a serving cell of terminal device 110 or 111. For example, reference signal receiving power (RSRP), reference signal receiving quality (RSRQ), signal to Interference plus Noise Ratio (SINR), and so on, which measured based on the downlink reference signal. For example, if the quality of the serving cell is below threshold quality, the A-IoT device may located at the edge of the cell coverage thus the access network device 120 may not access the A-IoT device 130 directly by itself. In another example, if the quality of the serving cell is above (i.e., higher than or equal to) a threshold quality, the A-IoT device may near the center of the cell coverage thus the access network device 120 may access the A-IoT device 130 directly by itself.

In some embodiments, the condition may be associated with capability for the communication with the A-IoT device 130. For example, the condition may include the terminal device 110 or 111 needs to support an A-IoT service. In another example, the condition may include the terminal device 110 or 111 needs to have an A-IoT signal transmitting or receiving function.

In some embodiments, the condition may be associated with an authentication or authorization status for the communication with the A-IoT device 130. For example, the condition may include the terminal device 110 or 111 needs to be authenticated or authorized by a core network as a legal A-IoT reader.

In some embodiments, the condition may be associated with an interference level measured by the terminal device 110 or 111. For example, the condition may include an interference level caused by surrounding environment allows the communication with the A-IoT device 130.

In some embodiments, the condition may be associated with a mobility status of the terminal device 110 or 111. For example, the condition may include the mobility status needs to be low or medium mobility determined based on state detection criteria existing or to be developed in future. In another example, the condition may include a moving velocity is below a threshold velocity.

In some embodiments, the condition may be associated with serving quality measured by the terminal device 110 or 111. In some embodiments, the serving quality may be quality of a serving cell of the terminal device 110 or 111. For example, the condition may include the quality of the serving cell is above threshold quality. In another example, the condition may include the quality of the serving cell is within a quality range.

Continue to refer to FIG. 3A, upon determination that a reader (e.g., the terminal device 111) fulfilling the condition, the access network device 120 initiates 320 the communication between the terminal device 111 and the A-IoT device 130. In some embodiments, the access network device 120 may transmit 321, to the terminal device 111, an indication for initiating the communication. Based on the indication, the terminal device 111 may initiate 322 the communication with the A-IoT device 130.

In this way, UEs may be selected to be involved in A-IoT communications, e.g., for warehouse inventory or sensor data collection.

A modification to the example of FIG. 3A will be described with reference to FIG. 3B. FIG. 3B illustrates a schematic diagram illustrating another example process 300B of initiating an A-IoT communication based on information collection according to embodiments of the present disclosure. For the purpose of discussion, the process 300B will be described with reference to FIG. 1. The process 300B may involve the terminal devices 110 and 111, the access network device 120 and the A-IoT device 130 as illustrated in FIG. 1. It is to be understood that the steps and the order of the steps in FIG. 3B are merely for illustration, and not for limitation. For example, the order of the steps may be changed. Some of the steps may be omitted or any other suitable additional steps may be added.

In this example, a terminal device (e.g., the terminal device 110) triggers an A-IoT communication with the A-IoT device 130 or reader selection, and the terminal devices 110 and 111 are readers. That is, the terminal device 110 serves as a trigger node.

As shown in FIG. 3B, the terminal device 110 determines 330 which reader fulfills a condition for communication with the A-IoT device 130. In some embodiments, the terminal device 110 may obtain 331, from other readers (e.g., the terminal device 111), information of the terminal device 111 associated with the communication. Based on the information of readers, the terminal device 110 may determine 332 a reader (e.g., the terminal device 111) fulfilling the condition.

Continue to refer to FIG. 3B, upon determination that a reader (e.g., the terminal device 111) fulfilling the condition, the terminal device 110 initiates 340 the communication between the terminal device 111 and the A-IoT device 130.

In some embodiments, the terminal device 110 may transmit 341, to the terminal device 111, an indication for initiating the communication. Based on the indication, the terminal device 111 may initiate 342 the communication with the A-IoT device 130. In this way, the terminal device 110 may directly initiate the communication between the terminal device 111 and the A-IoT device 130.

In some embodiments, the terminal device 110 may transmit 343, to the access network device 120, an indication that the terminal device 111 fulfills the condition for the communication with the A-IoT device 130. Upon reception of a confirmation from the access network device 120 or without the confirmation, the terminal device 110 may transmit 344, to the terminal device 111, an indication for initiating the communication. Based on the indication, the terminal device 111 may initiate 345 the communication with the A-IoT device 130. In this way, the terminal device 110 may initiate the communication between the terminal device 111 and the A-IoT device 130.

In some embodiments, the terminal device 110 may transmit 346, to the access network device 120, an indication that the terminal device 111 fulfills the condition for the communication with the A-IoT device 130. The access network device 120 may transmit 347, to the terminal device 111, an indication for initiating the communication. Based on the indication, the terminal device 111 may initiate 348 the communication with the A-IoT device 130. In this way, the terminal device 110 may indirectly initiate the communication between the terminal device 111 and the A-IoT device 130 via the access network device 120.

In this way, surrounding UEs may be selected to be involved in A-IoT communications (e.g., assist a trigger node to access an A-IoT device, like Object finding). It is to be understood that other details of information collection and condition evaluation in the process 300B are similar to that in the process 300A, and thus are not repeated here for concise.

FIG. 4A illustrates a schematic diagram illustrating an example process 400A of initiating an A-IoT communication based on condition provision according to embodiments of the present disclosure. For the purpose of discussion, the process 400A will be described with reference to FIG. 1. The process 400A may involve the terminal devices 110 and 111, the access network device 120 and the A-IoT device 130 as illustrated in FIG. 1. It is to be understood that the steps and the order of the steps in FIG. 4A are merely for illustration, and not for limitation. For example, the order of the steps may be changed. Some of the steps may be omitted or any other suitable additional steps may be added.

In this example, the access network device 120 triggers an A-IoT communication with the A-IoT device 130 or reader selection, and the terminal devices 110 and 111 are readers.

As shown in FIG. 4A, the access network device 120 may provide 410, to readers, information of a condition for communication with the A-IoT device 130. For example, the access network device 120 may transmit 411 the information of the condition to the terminal device 110, and transmit 412 the information of the condition to the terminal device 110. Accordingly, the terminal device 110 and 111 may determine whether the condition is fulfilled.

In some embodiments, the access network device 120 may provide information of the condition to the terminal device 110 or 111 via a broadcast signaling or MBS. In some embodiments, the access network device 120 may provide information of the condition to the terminal device 110 or 111 via a dedicated signaling.

Continue to refer to FIG. 4A, it is assumed that the terminal device 110 determines 420 that the terminal device 110 fulfills the condition for communication with the A-IoT device 130. In some embodiments, if the terminal device 110 fulfills the condition for a period of time, the terminal device 110 may determine that the terminal device 110 fulfills the condition.

In some embodiments for condition evaluation, the terminal device 110 may transmit a measurement and report configuration to the terminal device 111 via a sidelink transmission. In some embodiments, the measurement may be based on an energy supply signal. In some embodiments, the measurement may be based on a trigger signal. In some embodiments, the measurement may be based on a backscatter signal. In some embodiments, the report may be performed periodically. In some embodiments, the report may be performed after a period of time. In some embodiments, the report may be performed if a predetermined condition (e.g., serving quality is below threshold quality for a period of time) is fulfilled.

Upon the condition is fulfilled by the terminal device 110, the terminal device 110 initiates 430 the communication with the A-IoT device 130. In some embodiments, the terminal device 110 may directly initiates 431 the communication with the A-IoT device 130. In some embodiments, the terminal device 110 may transmit 432, to the access network device 120, an indication that the terminal device 110 fulfills the condition for the communication with the A-IoT device 130. In some embodiments, upon reception of a confirmation from the access network device 120, the terminal device 110 may initiate 433 the communication with the A-IoT device 130.

In this way, UE may evaluate A-IoT function related conditions provided by NW and determine to initiate an A-IoT procedure based on the conditions. It is to be understood that other details of condition evaluation in the process 400A are similar to that in the process 300A, and thus are not repeated here for concise.

A modification to the example of FIG. 4A will be described with reference to FIG. 4B. FIG. 4B illustrates a schematic diagram illustrating an example process 400B of initiating an A-IoT communication based on condition provision according to embodiments of the present disclosure. For the purpose of discussion, the process 400B will be described with reference to FIG. 1. The process 400B may involve the terminal devices 110 and 111, the access network device 120 and the A-IoT device 130 as illustrated in FIG. 1. It is to be understood that the steps and the order of the steps in FIG. 4B are merely for illustration, and not for limitation. For example, the order of the steps may be changed. Some of the steps may be omitted or any other suitable additional steps may be added.

In this example, a terminal device (e.g., the terminal device 110) triggers an A-IoT communication with the A-IoT device 130 or reader selection, and the terminal devices 110 and 111 are readers. That is, the terminal device 110 serves as a trigger node.

As shown in FIG. 4B, the terminal device 110 may transmit 440, to other readers (e.g., the terminal device 111), information of a condition for communication with the A-IoT device 130. Accordingly, the terminal device 110 and 111 may determine whether the condition is fulfilled.

In some embodiments, the terminal device 110 may provide information of the condition to the terminal device 111 via a sidelink broadcast signaling or groupcast signaling. In some embodiments, the terminal device 110 may provide information of the condition to the terminal device 111 via a sidelink dedicated signaling.

Continue to refer to FIG. 4B, it is assumed that the terminal device 111 determines 450 that the terminal device 111 fulfills the condition for communication with the A-IoT device 130. The terminal device 111 initiates 460 the communication with the A-IoT device 130.

In some embodiments, the terminal device 111 may directly initiates 461 the communication with the A-IoT device 130. In some embodiments, the terminal device 111 may transmit 462, to the access network device 120, an indication that the terminal device 111 fulfills the condition for the communication with the A-IoT device 130. In some embodiments, upon reception of a confirmation from the access network device 120, the terminal device 111 may initiate 463 the communication with the A-IoT device 130.

In some embodiments, the terminal device 111 may transmit 464, to the terminal device 110, an indication that the terminal device 111 fulfills the condition for the communication with the A-IoT device 130. The terminal device 110 transmit 465, to the access network device 120 that an indication that the terminal device 111 fulfills the condition for the communication with the A-IoT device 130. Upon reception of a confirmation from the access network device 120, the terminal device 110 may transmit 466 a confirmation to the terminal device 111. Upon reception of a confirmation from the terminal device 110, the terminal device 111 initiates 467 the communication with the A-IoT device 130.

In some embodiments, the terminal device 111 may transmit 464, to the terminal device 110, an indication that the terminal device 111 fulfills the condition for the communication with the A-IoT device 130. In some embodiments, upon reception of a confirmation from the terminal device 110, the terminal device 111 initiates 467 the communication with the A-IoT device 130.

In this way, UE may evaluate A-IoT function related conditions provided by a surrounding UE and determine to initiate an A-IoT procedure based on the conditions. It is to be understood that other details of condition evaluation in the process 400B are similar to that in the process 300A, and thus are not repeated here for concise.

### Example Implementation of Determination of Configuration

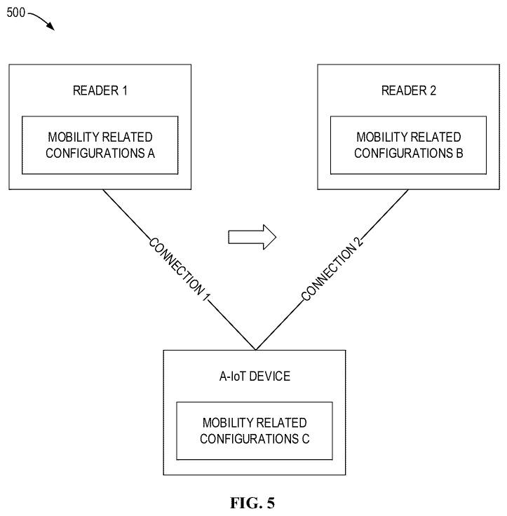

Embodiments of the present disclosure also provide a solution of determining a configuration of an A-IoT communication. In the solution, upon determination that an A-IoT device is to be changed from communicating with a source reader (also referred to as reader 1 herein) to communicating with a target reader (also referred to as reader 2 herein), a configuration associated with the change for communication between the target device and the A-IoT device is determined. More details will be description with reference to FIG. 5.

FIG. 5 illustrates a schematic diagram 500 illustrating an example reader change according to embodiments of the present disclosure. As shown in FIG. 5, an A-IoT device is to be changed from a connection 1 with reader 1 to a connection 2 with reader 2.

In some embodiments for the connection change, mobility related configurations B of the reader 2 may need to be changed to B′, and mobility related configurations C of the A-IoT device may keep unchanged. In some embodiments for the connection change, mobility related configurations C of the A-IoT device may need to be changed to C′, and mobility related configurations B of the reader 2 may keep unchanged. In some embodiments, mobility related configurations B of the reader 2 may need to be changed to B′, and mobility related configurations C of the A-IoT device may need to be changed to C′.

It is to be understood that a mobility procedure is not limited to changing from an individual reader to another. In some embodiments, reader 1 and reader 2 are not limited to an individual device. Identification information of reader 1 may correspond to a first set of readers, and identification information of reader 2 may correspond to a second set of readers. Configurations can be kept unchanged if the connection changes within the same set of readers. In this case, moving or changing connections from the first set of readers to the second set of readers may be considered to be a mobility procedure. Thus, a reader selection and re-selection may be a selection between different set of readers.

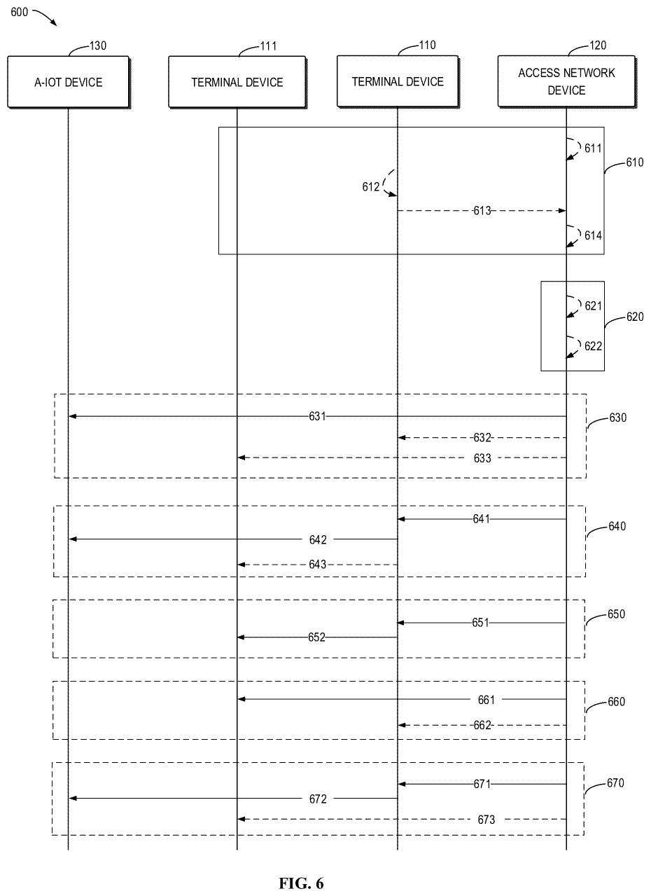

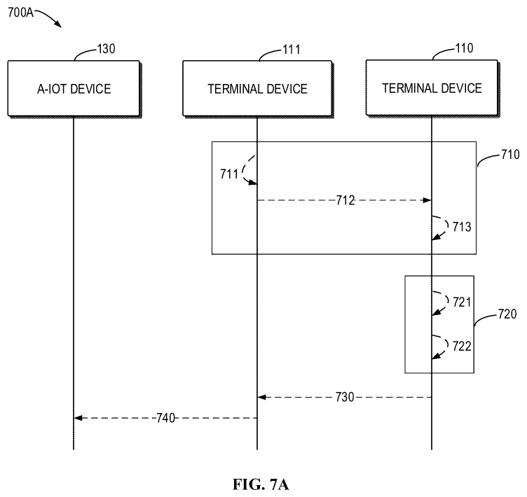

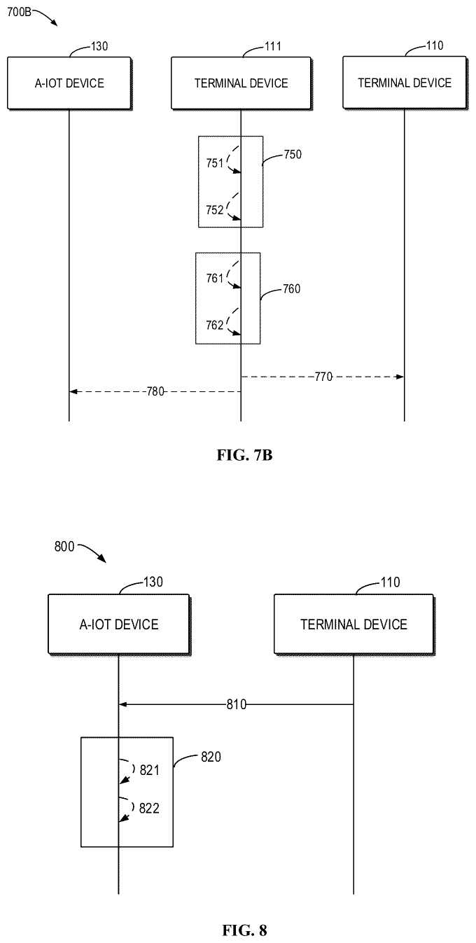

For illustration, some example embodiments will be described with reference to FIGS. 6 to 7B. FIG. 6 illustrates a schematic diagram illustrating an example process 600 of determining a configuration of an A-IoT communication by an access network device according to embodiments of the present disclosure. For the purpose of discussion, the process 600 will be described with reference to FIG. 1. The process 600 may involve the terminal devices 110 and 111, the access network device 120 and the A-IoT device 130 as illustrated in FIG. 1. It is to be understood that the steps and the order of the steps in FIG. 6 are merely for illustration, and not for limitation. For example, the order of the steps may be changed. Some of the steps may be omitted or any other suitable additional steps may be added.

As shown in FIG. 6, the access network device 120 determines 610 that the A-IoT device 130 is to be changed from communicating with a source reader (e.g., the terminal device 110) to communicating with a target reader (e.g., the terminal device 111). In some embodiments, if a set of conditions (i.e., a condition for a mobility procedure) is satisfied, the access network device 120 may determine 611 that the change is needed.

In some embodiments, the set of conditions may comprise that the change is indicated by an upper layer (e.g., application layer) of the access network device 120. In some embodiments, the set of conditions may comprise that an interference level of the terminal device 110 is above a threshold level. In some embodiments, the interference level may be evaluated by the access network device 120. In some embodiments, the interference level may be evaluated by the terminal device 110. In some embodiments, the interference level may be indicated to the access network device 120 in a measurement report from the terminal device 110.

In some embodiments, the set of conditions may comprise that quality of communication between the terminal device 110 and the A-IoT device 130 is below threshold communication quality. In some embodiments, the set of conditions may comprise that number of A-IoT devices served by the terminal device 110 is above a threshold number.

In some embodiments, the set of conditions may comprise that quality of a serving cell of the terminal device 110 is below first threshold quality. In some embodiments, the set of conditions may comprise that quality of a serving cell of the terminal device 110 is above second threshold quality.

In some embodiments, the set of conditions may comprise that a handover command is received or a cell change is indicated to be performed for the terminal device 110. In some embodiments, the set of conditions may comprise that a location of the terminal device 110 is changed. In some embodiments, the set of conditions may comprise that a mobility status of the terminal device 110 is changed.

It is to be understood that the set of conditions may comprise any combination of the above information. It is also to be understood that the set of conditions is merely described above by taking conditions associated with a source reader (e.g., the terminal device 110) as an example. In some embodiments, the conditions associated with the source reader described above may also be applied to a target reader (e.g., the terminal device 111). In other words, the set of conditions may comprise similar conditions associated with the target reader. In some embodiments, the set of conditions may comprise both the conditions associated with the source reader and the conditions associated with the target reader.

Continue to refer to FIG. 6, the terminal device 110 may determine 612 that a set of conditions are fulfilled. In some embodiments, the set of conditions may comprise that the change is indicated by an upper layer (e.g., application layer) of the terminal device 110. In some embodiments, the set of conditions may comprise that an interference level of the terminal device 110 is above a threshold level. In some embodiments, the interference level may be evaluated by the terminal device 110. In some embodiments, the set of conditions may comprise that quality of communication between the terminal device 110 and the A-IoT device 130 is below threshold communication quality. In some embodiments, the set of conditions may comprise that number of A-IoT devices served by the terminal device 110 is above a threshold number. In some embodiments, the set of conditions may comprise that quality of a serving cell of the terminal device 110 is below first threshold quality. In some embodiments, the set of conditions may comprise that quality of a serving cell of the terminal device 110 is above second threshold quality. In some embodiments, the set of conditions may comprise that a handover command is received or a cell change is indicated to be performed for the terminal device 110. In some embodiments, the set of conditions may comprise that a location of the terminal device 110 is changed. In some embodiments, the set of conditions may comprise that a mobility status of the terminal device 110 is changed.

Then the terminal device 110 may transmit 613, to the access network device 120, a request for the change. Based on the request, the access network device 120 may determine 614 that the A-IoT device 130 is to be changed from communicating with the source reader to communicating with the target reader.

With reference to FIG. 6, upon determination of the change, the access network device 120 determines 620 a configuration associated with the change. In some embodiments, the access network device 120 may select 621, as the target reader, a device (e.g., the terminal device 111) available for the communication with the A-IoT device 130.

Upon determination of the target reader, the access network device 120 may determine 622 the configuration associated with the change to the target reader. In some embodiments, the configuration associated with the change may comprise at least one of the following: a first configuration for the A-IoT device 130, a second configuration for the source reader (e.g., the terminal device 110), or a third configuration for the target reader (e.g., the terminal device 111).

Continue to refer to FIG. 6, in some embodiments, the access network device 120 may transmit 630 the configuration associated with the change in the following way. The access network device 120 may transmit 631, to the A-IoT device 130, a command comprising the first configuration. In this way, mobility related configurations for an A-IoT device may be updated for communication with a target reader.

As shown in FIG. 6, in some embodiments, the access network device 120 may also transmit 632 the second configuration to the terminal device 110. In this way, information (e.g., identity information) of the target reader may be informed to the source reader. In some embodiments, the access network device 120 may also transmit 633 the third configuration to the terminal device 111. In this way, mobility related configurations for a target reader may be updated for communication with an A-IoT device.

In some embodiments, the access network device 120 may periodically update the first configuration. That is, the access network device 120 may periodically transmit the command comprising the first configuration to the A-IoT device 130.

Continue to refer to FIG. 6, in some embodiments, the access network device 120 may transmit 640 the configuration associated with the change in the following way. The access network device 120 may transmit 641 the first configuration to the terminal device 110. The terminal device 110 may transmit 642, to the A-IoT device 130, a command comprising the first configuration. In some embodiments, the access network device 120 may also transmit the third configuration to the terminal device 110, and the terminal device 110 may transmit 643 the third configuration to the terminal device 111.

Continue to refer to FIG. 6, in some embodiments, the access network device 120 may transmit 650 the configuration associated with the change in the following way. The access network device 120 may transmit 651 the third configuration to the terminal device 110. The terminal device 110 may forward 652 the third configuration to the terminal device 111.

Continue to refer to FIG. 6, in some embodiments, the access network device 120 may transmit 660 the configuration associated with the change in the following way. The access network device 120 may transmit 661 the third configuration to the terminal device 111. In this way, the terminal device 111 may access the A-IoT device 130 based on the third configuration. In some embodiments, the access network device 120 may also transmit 662 the second configuration to the terminal device 110.

Continue to refer to FIG. 6, in some embodiments, the access network device 120 may transmit 670 the configuration associated with the change in the following way. The access network device 120 may transmit 671 the first configuration to the terminal device 110. The terminal device 110 may transmit 672 a command comprising the first configuration to the A-IoT device 130. In some embodiments, the access network device 120 may also transmit 673 the third configuration to the terminal device 111. In this way, the terminal device 111 may access the A-IoT device 130 based on the third configuration.

In some embodiments, upon determining to handover a reader (e.g., the terminal device 110) to other cell, the access network device 120 may determine that an A-IoT mobility procedure associate with the reader may be triggered. For the process 600, the access network device 120 may transmit a handover command to the source reader. In this case, the handover command may implicitly or explicitly indicate that A-IoT device is to be changed from communicating with a source reader (e.g., the terminal device 110) to communicating with a target reader (e.g., the terminal device 111). In some embodiments, the handover command comprises the second configuration for the source reader. In some embodiments, the third configuration may also be provided to a target reader via a re-configuration procedure.

FIG. 7A illustrates a schematic diagram illustrating an example process 700A of determining a configuration of an A-IoT communication by a terminal device according to embodiments of the present disclosure. For the purpose of discussion, the process 700A will be described with reference to FIG. 1. The process 700A may involve the terminal devices 110 and 111 and the A-IoT device 130 as illustrated in FIG. 1. It is to be understood that the steps and the order of the steps in FIG. 7A are merely for illustration, and not for limitation. For example, the order of the steps may be changed. Some of the steps may be omitted or any other suitable additional steps may be added.

As shown in FIG. 7A, the terminal device 110 determines 710 that the A-IoT device 130 is to be changed from communicating with a source reader (e.g., the terminal device 111) to communicating with a target reader. In some embodiments, the source reader (e.g., the terminal device 111) may determine 711 that a set of conditions are fulfilled. Then the terminal device 111 may transmit 712, to the terminal device 110, a request for the change to the terminal device 110. Based on the request, the terminal device 110 may determine 713 that the A-IoT device 130 is to be changed from communicating with the source reader to communicating with the target reader.

With reference to FIG. 7A, upon determination of the change, the terminal device 110 determines 720 a configuration associated with the change. In some embodiments, the terminal device 110 may select 721, as the target reader, a device (e.g., the terminal device 110 or other readers) available for the communication with the A-IoT device 130. Upon determination of the target reader, the terminal device 110 may determine 722 the configuration associated with the change to the target reader. In some embodiments, the configuration associated with the change may comprise at least one of the following: a first configuration for the A-IoT device 130, a second configuration for the source reader (e.g., the terminal device 111), or a third configuration for a suggested target reader. In some embodiments, the configuration associated with the change may comprise a confirmation to be the target reader. In some embodiments, the configuration associated with the change may comprise information of the suggested target reader. For example, the terminal device 111 may transmit 712, to the terminal device 110, a request for terminal device 110 to be the target reader and receive the confirmation from the terminal device 110. In some embodiments, the terminal device 111 may receive confirmation from the terminal device 110 or information of suggested target reader from the terminal device 110. Upon confirmed by the terminal device 110 or receive information of suggested target reader, the terminal device 111 may determine 722 the configuration associated with the change.

Continue to refer to FIG. 7A, the terminal device 110 transmits 730 the configuration associated with the change to the terminal device 111. The terminal device 111 may transmit 740 a command comprising the first configuration to the A-IoT device 130. In this way, update of a mobility related configuration for the A-IoT device 130 may be facilitated. In some embodiments where the information of the suggested target reader is received, the terminal device 111 may initiate other reader selection procedure, e.g., for the suggested target reader.

In some embodiments, the terminal device 110 may transmit the third configuration to the suggested target reader. In this way, the suggested target reader may access the A-IoT device 130. In some embodiments, the terminal device 110 or 111 may forward the configuration associated with the change to a network.

With the process 700A, UE may perform reader selection and initiate a mobility related procedure. It is to be understood that other details of condition evaluation in the process 700A are similar to that in the process 600, and thus are not repeated here for concise.

FIG. 7B illustrates a schematic diagram illustrating another example process 700B of determining a configuration of an A-IoT communication by a terminal device according to embodiments of the present disclosure. For the purpose of discussion, the process 700B will be described with reference to FIG. 1. The process 700B may involve the terminal devices 110 and 111 and the A-IoT device 130 as illustrated in FIG. 1. It is to be understood that the steps and the order of the steps in FIG. 7B are merely for illustration, and not for limitation. For example, the order of the steps may be changed. Some of the steps may be omitted or any other suitable additional steps may be added. In this example, a source reader performs a reader selection.

As shown in FIG. 7B, the terminal device 111 determines 750 that the A-IoT device 130 is to be changed from communicating with the terminal device 111 to communicating with a target reader. In some embodiments, the terminal device 111 may determine 751 that a set of conditions are fulfilled. Then the terminal device 111 may determine 752 that the A-IoT device 130 is to be changed from communicating with the terminal device 111 to communicating with the target reader.

With reference to FIG. 7B, upon determination of the change, the terminal device 110 determines 760 a configuration associated with the change. In some embodiments, the terminal device 110 may select 761, as the target reader, a device (e.g., the terminal device 110 or other readers) available for the communication with the A-IoT device 130. Upon determination of the target reader, the terminal device 110 may determine 762 the configuration associated with the change to the target reader. In some embodiments, the configuration associated with the change may comprise at least one of the following: a first configuration for the A-IoT device 130, a second configuration for the source reader (e.g., the terminal device 111), or a third configuration for a suggested target reader (e.g., the terminal device 110).

Continue to refer to FIG. 7B, in some embodiments, the terminal device 111 may transmit 770, to the terminal device 110, the configuration associated with the change. In this way, the terminal device 110 may access the A-IoT device 130. In some embodiments, the terminal device 111 may transmit 780 a command comprising the first configuration to the A-IoT device 130. In this way, update of a mobility related configuration for the A-IoT device 130 may be facilitated. In some embodiments, the terminal device 111 may forward the configuration associated with the change to a network.

With the process 700B, UE as a source reader may perform reader selection and initiate a mobility related procedure. It is to be understood that other details of condition evaluation in the process 700B are similar to that in the process 600, and thus are not repeated here for concise.

### Example Implementation of Update of Configuration

Embodiments of the present disclosure also provide a solution of updating a configuration of an A-IoT communication. More details will be description with reference to FIG. 8.

FIG. 8 illustrates a schematic diagram illustrating a process 800 of updating a configuration of an A-IoT communication according to embodiments of the present disclosure. For the purpose of discussion, the process 800 will be described with reference to FIG. 1. The process 800 may involve a reader and the A-IoT device 130 as illustrated in FIG. 1. It is to be understood that the steps and the order of the steps in FIG. 8 are merely for illustration, and not for limitation. For example, the order of the steps may be changed. Some of the steps may be omitted or any other suitable additional steps may be added. For convenience, the following description is given by taking the terminal device 110 as an example of the reader. It is to be understood that the reader may be the terminal device 111 or the access network device 120.

As shown in FIG. 8, a reader (e.g., the terminal device 110) transmits 810, to the A-IoT device 130, a command associated with a change of the A-IoT device 130 from communicating with a source reader to communicating with a target reader.

In some embodiments, the command may be initiated by an upper layer of the terminal device 110. In some embodiments, the command may be initiated by the access network device 120. In some embodiments, the command may be initiated by the core network device 140 (e.g., AMF or AF). In some embodiments, the command may be initiated by the A-IoT server 150.

Continue to refer to FIG. 8, based on the command, the A-IoT device 130 may update 820 a configuration associated with the change. In some embodiments, the configuration associated with the change may comprise at least one of the following: information of a set of candidate devices; information of a set of activated candidate devices in the set of candidate devices; or a security configuration.

With reference to FIG. 8, in some embodiments, the A-IoT device 130 may determine 821 whether to update the configuration based on the information of candidate devices or activated candidate devices in the set of candidate devices.

In some embodiments, if the command is received from a candidate device in the set of candidate devices, the A-IoT device 130 may update the configuration associated with the change based on the command. In some embodiments, if the command is received from an activated candidate device in the set of candidate devices, the A-IoT device 130 may update the configuration associated with the change based on the command.

In some embodiments, if the command is received from a candidate device or an activated candidate device in the set of candidate devices and that the target reader is a further candidate device in the set of candidate devices, the A-IoT device 130 may update the configuration associated with the change based on the command. In some embodiments, if the command is received from a candidate device or an activated candidate device in the set of candidate devices and that the target reader is an activated further candidate device in the set of candidate devices, the A-IoT device 130 may update the configuration associated with the change based on the command.

With reference to FIG. 8, in some embodiments, the A-IoT device 130 may determine 822 whether to update the configuration based on the security configuration. In some embodiments, if security information of the terminal device 110 matches the security configuration, that is, the command is received from a legal reader, the A-IoT device 130 may update the configuration associated with the change based on the command. It is to be understood that any combination of the above information may also be used for triggering the update.

In some embodiments, updating the configuration associated with the change may comprise configuring the configuration. In some embodiments, updating the configuration associated with the change may comprise modifying the configuration. In some embodiments, updating the configuration associated with the change may comprise adding the configuration. In some embodiments, updating the configuration associated with the change may comprise removing the configuration.

With the process 800, mobility related configurations may be selectively updated.

### Example Implementation of Access Check

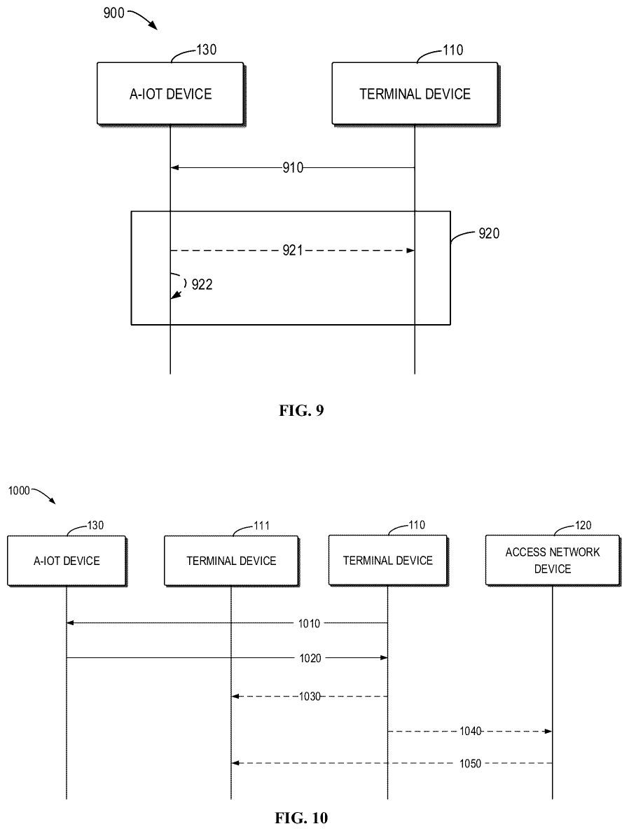

Embodiments of the present disclosure also provide a solution of A-IoT communication with access check. More details will be description with reference to FIG. 9.

FIG. 9 illustrates a schematic diagram illustrating a process 900 of an A-IoT communication with access check according to embodiments of the present disclosure. For the purpose of discussion, the process 900 will be described with reference to FIG. 1. The process 900 may involve a reader and the A-IoT device 130 as illustrated in FIG. 1. It is to be understood that the steps and the order of the steps in FIG. 9 are merely for illustration, and not for limitation. For example, the order of the steps may be changed. Some of the steps may be omitted or any other suitable additional steps may be added. For convenience, the following description is given by taking the terminal device 110 as an example of the reader. It is to be understood that the reader may be the terminal device 111 or the access network device 120.

As shown in FIG. 9, a reader (e.g., the terminal device 110) transmits 910 a command for A-IoT communication to the A-IoT device 130. Upon reception of the command, the reader (e.g., the terminal device 110) determines 920 whether information of the reader in the command matches a configuration of the A-IoT device 130.

In some embodiments, the configuration of the A-IoT device 130 may be pre-configured information. In some embodiments, the configuration of the A-IoT device 130 may be semi-static information. In some embodiments, the semi-static information may be updated (e.g., reconfigured or modified) by a reader.

In some embodiments, the configuration of the A-IoT device 130 may comprise at least one of the following: information of a set of candidate devices; information of a set of activated candidate devices in the set of candidate devices; or a security configuration.

With reference to FIG. 9, if information of the reader in the command matches a configuration of the A-IoT device 130, the A-IoT device 130 responses 930 to the command.

In some embodiments, if the information of the reader matches the information of a candidate device in the set of candidate devices, the A-IoT device 130 may response to the command. In some embodiments, if the information of the reader matches the information of a candidate device in the set of candidate devices and the candidate device is activated, the A-IoT device 130 may response to the command. In some embodiments, if the information of the reader matches the security configuration, the A-IoT device 130 may response to the command.

With reference to FIG. 9, in some embodiments, responding to the command may comprise transmitting 921 a response message. In some embodiments, responding to the command may comprise performing 922 an action indicated by the command.

With the process 900, access check at an A-IoT device may be achieved and selective response to an A-IoT command may be achieved.

### Example Implementation of Delivery of Mobility Information

Embodiments of the present disclosure also provide a solution of A-IoT communication for mobility information delivery. More details will be description with reference to FIG. 10.

FIG. 10 illustrates a schematic diagram illustrating a process 1000 of an A-IoT communication for mobility information delivery according to embodiments of the present disclosure. For the purpose of discussion, the process 1000 will be described with reference to FIG. 1. The process 1000 may involve the terminal devices 110 and 111, the A-IoT device 130 and the access network device 140 as illustrated in FIG. 1. It is to be understood that the steps and the order of the steps in FIG. 10 are merely for illustration, and not for limitation. For example, the order of the steps may be changed. Some of the steps may be omitted or any other suitable additional steps may be added. For convenience, the following description is given by taking the terminal device 110 as an example of the reader. It is to be understood that the reader may be the terminal device 111 or the access network device 120.

As shown in FIG. 10, a reader (e.g., the terminal device 110) transmits 1010, to the A-IoT device 130, a command for obtaining mobility information of the A-IoT device 130.

With reference to FIG. 10, upon reception of the command, the A-IoT device 130 may transmit 1020, to the reader (e.g., the terminal device 110), the mobility information of the A-IoT device 130.

In some embodiments, the mobility information may comprise information of a last connection of the A-IoT device 130. In some embodiments, the information of the last connection may comprise identification information of a last connected reader (a terminal device or an access network device). In some embodiments, the information of the last connection may comprise identification information of a last activated reader, e.g., UE_ID or a physical cell identifier (PCI).

In some embodiments, the mobility information may comprise a configuration associated with a change of the A-IoT device 130 from communicating with a source reader (e.g., the terminal device 111) to communicating with a target reader (e.g., the terminal device 110). In some embodiments, the configuration associated with the change may comprise at least one of the following: information of a set of candidate devices; information of a set of activated candidate devices in the set of candidate devices; or a security configuration (e.g., a password).

Continue to refer to FIG. 10, in some embodiments, the terminal device 110 may transmit 1030, to the last reader (e.g., the terminal device 111), information associated with the mobility information of the A-IoT device 130. In some embodiments, the terminal device 110 may transmit 1040, to the access network device 120, the information associated with the mobility information of the A-IoT device 130, and the access network device 120 may forward 1050 the information associated with the mobility information of the A-IoT device 130 to the last reader (e.g., the terminal device 111). In some embodiments, the access network device 120 may forward the information associated with the mobility information of the A-IoT device 130 to other potential readers.

In some embodiments, the obtaining and forwarding of the mobility information may be triggered based on an indication from a network. In some embodiments, the obtaining and forwarding of the mobility information may be triggered periodically.

With the process 1000, a source reader may be aware of the leaving of an A-IoT device. Further, the source reader or other readers or NW may be aware of the change of the serving reader or the current serving reader or candidate readers. This may assist to reach an A-IoT device for further A-IoT access. For further A-IoT access to an A-IoT device, a reader may try to reach the A-IoT device based on the mobility information.

It is to be understood that the above processes 300A to 1000 may be carried out separately or in any suitable combination. The present disclosure does not limit this aspect.

### Example Implementation of Methods

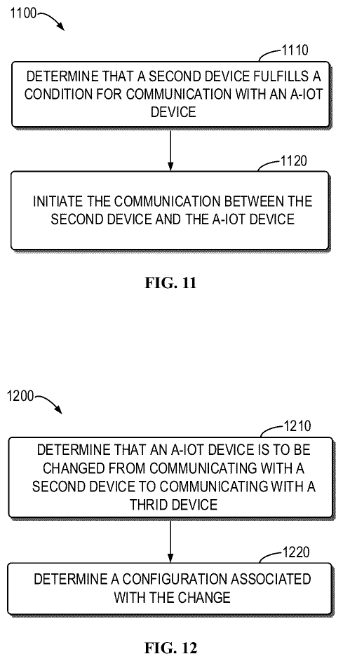

Corresponding to the above processes, embodiments of the present disclosure provide methods of communication implemented at a first device (i.e., a reader) and an A-IoT device. The reader may be a terminal device or an access network device. These methods will be described below with reference to FIGS. 11 to 15.

FIG. 11 illustrates an example method 1100 of communication implemented at a first device in accordance with some embodiments of the present disclosure. For the purpose of discussion, in the following, the method 1100 will be described with reference to FIG. 1. The first device is a reader of the A-IoT device 130. It is to be understood that the method 1100 may include additional blocks not shown and/or may omit some blocks as shown, and the scope of the present disclosure is not limited in this regard.

At block 1110, the first device (e.g., the terminal device 110 or 111 or the access network device 120) determines that a second device (e.g., the terminal device 110 or 111 or the access network device 120) fulfills a condition for communication with the A-IoT device 130.

At block 1120, the first device initiates the communication between the second device and the A-IoT device 130.

In some embodiments, the first device may determine that the second device fulfills the condition by: obtaining, from the second device, information of the second device associated with the communication; and determining, based on the information of the second device, that the second device fulfills the condition.

In some embodiments, the information is associated with at least one of the following: capability for the communication with the A-IoT device 130; an authentication status for the communication with the A-IoT device 130; an authorization status for the communication with the A-IoT device 130; an interference level measured by the second device; a mobility status of the second device; or serving quality measured by the second device.

In some embodiments where the first device is an access network device and the second device is a terminal device, the first device may initiate the communication by: transmitting, to the second device, an indication for initiating the communication.

In some embodiments where the first device and the second device are terminal devices, the first device may initiate the communication by: transmitting, to the second device, an indication for initiating the communication. In these embodiments, the first device may transmit, to an access network device (e.g., the access network device 120), an indication that the second device fulfills the condition for the communication with the A-IoT device 130.

In some embodiments where the first device and the second device are terminal devices, the first device may initiate the communication by: transmitting, to an access network device (e.g., the access network device 120), an indication that the second device fulfills the condition for the communication with the A-IoT device 130. In this way, the access network device 120 may transmit an indication for initiating the communication to the second device.

In some embodiments where the second device is the first device, the first device may further receive, from a third device, information of the condition. In some embodiments where the first device is a terminal device and the third device is an access network device, the first device may transmit, to the third device, an indication that the first device fulfills the condition for the communication with the A-IoT device 130. In some embodiments where the first device and third device are terminal devices, the first device may transmit, to the third device or to the access network device 120, an indication that the first device fulfills the condition for the communication with the A-IoT device 130.

In some embodiments, the condition may be associated with at least one of the following: capability for the communication with the A-IoT device 130; an authentication status for the communication with the A-IoT device 130; an authorization status for the communication with the A-IoT device 130; an interference level measured by the second device; mobility status of the second device; or serving quality measured by the second device.

With the method 1100, a reader selection procedure may be specified.

FIG. 12 illustrates another example method 1200 of communication implemented at a first device in accordance with some embodiments of the present disclosure. For the purpose of discussion, in the following, the method 1200 will be described with reference to FIG. 1. The first device is a reader of the A-IoT device 130. It is to be understood that the method 1200 may include additional blocks not shown and/or may omit some blocks as shown, and the scope of the present disclosure is not limited in this regard.

At block 1210, the first device (e.g., the terminal device 110 or 111 or the access network device 120) determines that the A-IoT device 130 is to be changed from communicating with a second device (e.g., the terminal device 110 or 111 or the access network device 120) to communicating with a third device (e.g., the terminal device 110 or 111 or the access network device 120).

At block 1220, the first device determines a configuration associated with the change for communication between the third device and the A-IoT device 130.

In some embodiments, if a set of conditions is satisfied, the first device may determine that the A-IoT device 130 is to be changed from communicating with the second device to communicating with the third device. In some embodiments, the set of conditions may comprise at least one of the following: the change is indicated by an upper layer of the first device; an interference level of the second device is above a threshold level; quality of communication between the second device and the A-IoT device is below threshold communication quality; number of A-IoT devices served by the second device is above a threshold number; quality of a serving cell of the second device is below first threshold quality; quality of a serving cell of the second device is above second threshold quality; a handover command is received or a cell change is indicated to be performed for the second device; a location of the second device is changed; or a mobility status of the second device is changed.

In some embodiments, the first device may receive, from the second device, a request for the change. Based on the request, the first device may determine that the A-IoT device 130 is to be changed from communicating with the second device to communicating with the third device.

In some embodiments, the first device may select, as the third device, a device available for the communication with the A-IoT device 130, and determine the configuration associated with the change to the third device. In some embodiments, the configuration may comprise at least one of the following: a first configuration for the A-IoT device 130, a second configuration for the second device, or a third configuration for the third device.

In some embodiments, the first device may transmit, to the A-IoT device 130, a command comprising the first configuration. In some embodiments, the first device may transmit the second configuration to the second device. In some embodiments, the first device may transmit the third configuration to the third device.

In some embodiments, the first device may be the second device.

With the method 1200, mobility related configurations may be determined.

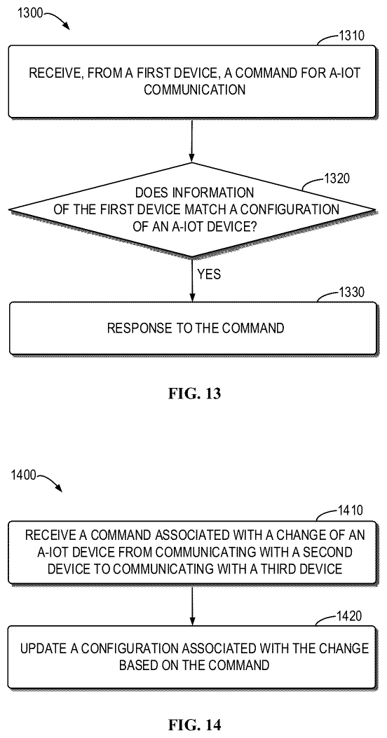

FIG. 13 illustrates an example method 1300 of communication implemented at an A-IoT device in accordance with some embodiments of the present disclosure. For example, the method 1300 may be performed at the A-IoT device 120 as shown in FIG. 1. For the purpose of discussion, in the following, the method 1300 will be described with reference to FIG. 1. It is to be understood that the method 1300 may include additional blocks not shown and/or may omit some blocks as shown, and the scope of the present disclosure is not limited in this regard.

At block 1310, the A-IoT device 130 receives, from a first device, a command for A-IoT communication. The first device is a reader. The first device may be the terminal device 110 or 111 or the access network device 120.

At block 1320, the A-IoT device 130 determines whether information of the first device in the command matches a configuration of the A-IoT device 130. In some embodiments, the configuration may comprise at least one of the following: information of a set of candidate devices; information of a set of activated candidate devices in the set of candidate devices; or a security configuration.

If the information of the first device in the command matches the configuration of the A-IoT device 130, the method 1300 proceeds to block 1330. At block 1330, the A-IoT device 130 responses to the command.

In some embodiments, if the information of the first device matches the information of a candidate device in the set of candidate devices, the A-IoT device 130 may response to the command.

In some embodiments, if the information of the first device matches the information of a candidate device in the set of candidate devices and the candidate device is activated, the A-IoT device 130 may response to the command.

In some embodiments, if the information of the first device matches the security configuration, the A-IoT device 130 may response to the command.

With the method 1300, access check at an A-IoT device may be achieved and a selective response to an A-IoT command may be achieved.

FIG. 14 illustrates another example method 1400 of communication implemented at an A-IoT device in accordance with some embodiments of the present disclosure. For example, the method 1400 may be performed at the A-IoT device 130 as shown in FIG. 1. For the purpose of discussion, in the following, the method 1400 will be described with reference to FIG. 1. It is to be understood that the method 1400 may include additional blocks not shown and/or may omit some blocks as shown, and the scope of the present disclosure is not limited in this regard.

At block 1410, the A-IoT device 130 receives a command associated with a change of the A-IoT device 130 from communicating with a second device to communicating with a third device.

At block 1420, the A-IoT device 130 updates, based on the command, a configuration associated with the change. In some embodiments, the configuration associated with the change may comprise at least one of the following: information of a set of candidate devices; information of a set of activated candidate devices in the set of candidate devices; or a security configuration.

In some embodiments where the configuration associated with the change comprises information of a set of candidate devices, if the command is received from a candidate device or an activated candidate device in the set of candidate devices, the A-IoT device 130 may update the configuration associated with the change based on the command.

In some embodiments where the configuration associated with the change comprises information of a set of candidate devices, if the command is received from a candidate device or an activated candidate device in the set of candidate devices and that the third device is a further candidate device or an activated further candidate device in the set of candidate devices, the A-IoT device 130 may update the configuration associated with the change based on the command.

With the method 1400, mobility related configurations may be selectively updated.

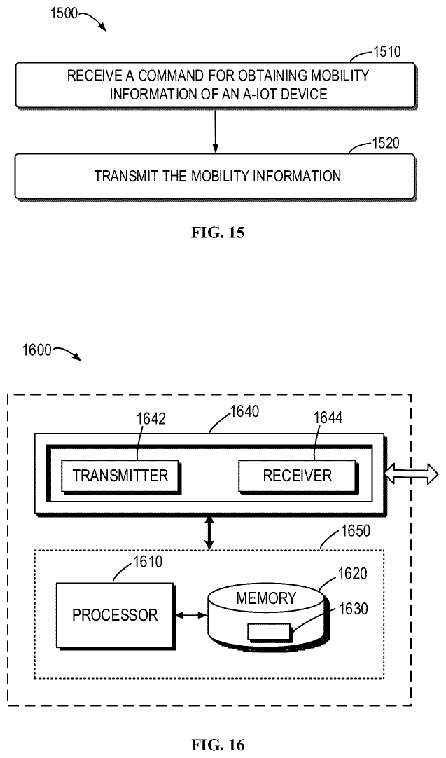

FIG. 15 illustrates still another example method 1500 of communication implemented at an A-IoT device in accordance with some embodiments of the present disclosure. For example, the method 1500 may be performed at the A-IoT device 130 as shown in FIG. 1. For the purpose of discussion, in the following, the method 1500 will be described with reference to FIG. 1. It is to be understood that the method 1500 may include additional blocks not shown and/or may omit some blocks as shown, and the scope of the present disclosure is not limited in this regard.

At block 1510, the A-IoT device 130 receives a command for obtaining mobility information of the A-IoT device 130.

At block 1520, the A-IoT device 130 transmits the mobility information of the A-IoT device 130.

In some embodiments, the mobility information may comprise at least one of the following: information of a last connection of the A-IoT device 130; or a configuration associated with a change of the A-IoT device from communicating with a second device to communicating with a third device. In some embodiments, the configuration associated with the change may comprise at least one of the following: information of a set of candidate devices; information of a set of activated candidate devices in the set of candidate devices; or a security configuration.

With the method 1500, mobility information of an A-IoT device may be delivered.

It is to be understood that operations of the methods 1100 to 1500 correspond to that described with reference to FIGS. 3A to 10, and thus other details are not repeated here for concise.

### Example Implementation of Devices

FIG. 16 is a simplified block diagram of a device 1600 that is suitable for implementing embodiments of the present disclosure. The device 1600 can be considered as a further example implementation of the terminal device 110 or 111 or the access network device 120 or the core network device 140 as shown in FIG. 1. Accordingly, the device 1600 can be implemented at or as at least a part of the terminal device 110 or 111 or the access network device 120 or the core network device 140.

As shown, the device 1600 includes a processor 1610, a memory 1620 coupled to the processor 1610, a suitable transceiver 1640 coupled to the processor 1610, and a communication interface coupled to the transceiver 1640. The memory 1610 stores at least a part of a program 1630. The transceiver 1640 may be for bidirectional communications or a unidirectional communication based on requirements. The transceiver 1640 may include at least one of a transmitter 1642 or a receiver 1644. The transmitter 1642 and the receiver 1644 may be functional modules or physical entities. The transceiver 1640 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1630 is assumed to include program instructions that, when executed by the associated processor 1610, enable the device 1600 to operate in accordance with the embodiments of the present disclosure, as discussed herein with reference to FIGS. 1 to 15. The embodiments herein may be implemented by computer software executable by the processor 1610 of the device 1600, or by hardware, or by a combination of software and hardware. The processor 1610 may be configured to implement various embodiments of the present disclosure. Furthermore, a combination of the processor 1610 and memory 1620 may form processing means 1650 adapted to implement various embodiments of the present disclosure.

The memory 1620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1620 is shown in the device 1600, there may be several physically distinct memory modules in the device 1600. The processor 1610 may be of any type suitable to the local technical network, and may include one or more of general purpose computers, special purpose computers, microprocessors, digital signal processors (DSPs) and processors based on multicore processor architecture, as non-limiting examples. The device 1600 may have multiple processors, such as an application specific integrated circuit chip that is slaved in time to a clock which synchronizes the main processor.

In some embodiments, a first device comprises a circuitry configured to: determine that a second device fulfills a condition for communication with an A-IoT device; and initiate the communication between the second device and the A-IoT device.

In some embodiments, a first device comprises a circuitry configured to: determine that an A-IoT device is to be changed from communicating with a second device to communicating with a third device; and determine a configuration associated with the change for communication between the third device and the A-IoT device.

In some embodiments, an A-IoT device comprises a circuitry configured to: receive, from a first device, a command for A-IoT communication; and in accordance with a determination that information of the first device in the command matches a configuration of the A-IoT device, response to the command.

In some embodiments, an A-IoT device comprises a circuitry configured to: receive a command associated with a change of the A-IoT device from communicating with a second device to communicating with a third device; and update, based on the command, a configuration associated with the change.

In some embodiments, an A-IoT device comprises a circuitry configured to: receive a command for obtaining mobility information of the A-IoT device; and transmit the mobility information of the A-IoT device.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a first device comprises a processor configured to cause the first device to: determine that a second device fulfills a condition for communication with an ambient Internet of things (A-IoT) device; and initiate the communication between the second device and the A-IoT device.

In some embodiments, the first device is caused to determine that the second device fulfills the condition by: obtaining, from the second device, information of the second device associated with the communication; and determining, based on the information of the second device, that the second device fulfills the condition.

In some embodiments, the information is associated with at least one of the following: capability for the communication with the A-IoT device; an authentication status for the communication with the A-IoT device; an authorization status for the communication with the A-IoT device; an interference level measured by the second device; a mobility status of the second device; or serving quality measured by the second device.

In some embodiments, the first device is an access network device, and the second device is a terminal device. In some embodiments, the first device is caused to initiate the communication by: transmitting, to the second device, an indication for initiating the communication.

In some embodiments, the first device and the second device are terminal devices. In some embodiments, the first device is caused to initiate the communication by: transmitting, to the second device, an indication for initiating the communication. In some embodiments, the first device is further caused to: transmit, to an access network device, an indication that the second device fulfills the condition for the communication with the A-IoT device.

In some embodiments where the first device and the second device are terminal devices, the first device is caused to initiate the communication by: transmitting, to an access network device, an indication that the second device fulfills the condition for the communication with the A-IoT device, an indication for initiating the communication being transmitted by the access network device to the second device.

In some embodiments, the second device is the first device, and the first device is further caused to: receive, from a third device, information of the condition.

In some embodiments, the first device is a terminal device, and the third device is an access network device. In some embodiments, the first device is further caused to: transmit, to the third device, an indication that the first device fulfills the condition for the communication with the A-IoT device.

In some embodiments, the first device and third device are terminal devices. In some embodiments, the first device is further caused to: transmit, to the third device or to an access network device, an indication that the first device fulfills the condition for the communication with the A-IoT device.

In some embodiments, the condition is associated with at least one of the following: capability for the communication with the A-IoT device; an authentication status for the communication with the A-IoT device; an authorization status for the communication with the A-IoT device; an interference level measured by the second device; mobility status of the second device; or serving quality measured by the second device.

In another solution, a first device comprises a processor configured to cause the first device to: determine that an ambient Internet of things (A-IoT) device is to be changed from communicating with a second device to communicating with a third device; and determine a configuration associated with the change for communication between the third device and the A-IoT device.

In some embodiments, the first device is caused to determine that the A-IoT device is to be changed from communicating with the second device to communicating with the third device by: in accordance with a determination that a set of conditions is satisfied, determining that the A-IoT device is to be changed from communicating with the second device to communicating with the third device. The set of conditions comprises at least one of the following: the change is indicated by an upper layer of the first device; an interference level of the second device is above a threshold level; quality of communication between the second device and the A-IoT device is below threshold communication quality; number of A-IoT devices served by the second device is above a threshold number; quality of a serving cell of the second device is below first threshold quality; quality of a serving cell of the second device is above second threshold quality; a handover command is received or a cell change is indicated to be performed for the second device; a location of the second device is changed; or a mobility status of the second device is changed.

In some embodiments, the first device is caused to determine that the A-IoT device is to be changed from communicating with the second device to communicating with the third device by: receiving, from the second device, a request for the change; and determining that the A-IoT device is to be changed from communicating with the second device to communicating with the third device.

In some embodiments, the first device is caused to determine the configuration associated with the change by: selecting, as the third device, a device available for the communication with the A-IoT device; and determining the configuration associated with the change comprising at least one of the following: a first configuration for the A-IoT device, a second configuration for the second device, or a third configuration for the third device.

In some embodiments, the first device is further caused to at least one of the following: transmit, to the A-IoT device, a command comprising the first configuration; transmit the second configuration to the second device; or transmit the third configuration to the third device.

In some embodiments, the first device is the second device.

In another solution, an ambient Internet of things (A-IoT) device comprises a processor configured to cause the A-IoT device to: receive, from a first device, a command for A-IoT communication; and in accordance with a determination that information of the first device in the command matches a configuration of the A-IoT device, response to the command.

In some embodiments, the configuration comprises at least one of the following: information of a set of candidate devices; information of a set of activated candidate devices in the set of candidate devices; or a security configuration.

In some embodiments, the A-IoT device is caused to response to the command by: in accordance with a determination that the information of the first device matches the information of a candidate device in the set of candidate devices, responsing to the command.

In some embodiments, the A-IoT device is caused to response to the command by: in accordance with a determination that the candidate device is activated, responsing to the command.

In some embodiments, the A-IoT device is caused to response to the command by: in accordance with a determination that the information of the first device matches the security configuration, responsing to the command.

In another solution, an ambient Internet of things (A-IoT) device comprises a processor configured to cause the A-IoT device to: receive a command associated with a change of the A-IoT device from communicating with a second device to communicating with a third device; and update, based on the command, a configuration associated with the change.

In some embodiments, the configuration associated with the change comprises at least one of the following: information of a set of candidate devices; information of a set of activated candidate devices in the set of candidate devices; or a security configuration.

In some embodiments, the configuration associated with the change comprises information of a set of candidate devices, and the A-IoT device is caused to update the configuration by: in accordance with a determination that the command is received from a candidate device or an activated candidate device in the set of candidate devices, updating the configuration associated with the change based on the command; or in accordance with a determination that the command is received from a candidate device or an activated candidate device in the set of candidate devices and that the third device is a further candidate device or an activated further candidate device in the set of candidate devices, updating the configuration associated with the change based on the command.

In another solution, an ambient Internet of things (A-IoT) device comprises a processor configured to cause the A-IoT device to: receive a command for obtaining mobility information of the A-IoT device; and transmit the mobility information of the A-IoT device.

In some embodiments, the mobility information comprises at least one of the following: information of a last connection of the A-IoT device; or a configuration associated with a change of the A-IoT device from communicating with a second device to communicating with a third device.

In some embodiments, the configuration associated with the change comprises at least one of the following: information of a set of candidate devices; information of a set of activated candidate devices in the set of candidate devices; or a security configuration.

In another solution, a method of communication comprises: determining, at a first device, that a second device fulfills a condition for communication with an ambient Internet of things (A-IoT) device; and initiating the communication between the second device and the A-IoT device.

In some embodiments, determining that the second device fulfills the condition comprises: obtaining, from the second device, information of the second device associated with the communication; and determining, based on the information of the second device, that the second device fulfills the condition.

In some embodiments, the information is associated with at least one of the following: capability for the communication with the A-IoT device; an authentication status for the communication with the A-IoT device; an authorization status for the communication with the A-IoT device; an interference level measured by the second device; a mobility status of the second device; or serving quality measured by the second device.

In some embodiments, the first device is an access network device, and the second device is a terminal device. In some embodiments, initiating the communication comprises: transmitting, to the second device, an indication for initiating the communication.

In some embodiments, the first device and the second device are terminal devices. In some embodiments, initiating the communication comprises: transmitting, to the second device, an indication for initiating the communication. In some embodiments, the method further comprises: transmitting, to an access network device, an indication that the second device fulfills the condition for the communication with the A-IoT device.

In some embodiments where the first device and the second device are terminal devices, initiating the communication comprises: transmitting, to an access network device, an indication that the second device fulfills the condition for the communication with the A-IoT device, an indication for initiating the communication being transmitted by the access network device to the second device.

In some embodiments, the second device is the first device, and the method further comprises: receiving, from a third device, information of the condition.

In some embodiments, the first device is a terminal device, and the third device is an access network device. In some embodiments, the method further comprises: transmitting, to the third device, an indication that the first device fulfills the condition for the communication with the A-IoT device.

In some embodiments, the first device and third device are terminal devices. In some embodiments, the method further comprises: transmitting, to the third device or to an access network device, an indication that the first device fulfills the condition for the communication with the A-IoT device.

In some embodiments, the condition is associated with at least one of the following: capability for the communication with the A-IoT device; an authentication status for the communication with the A-IoT device; an authorization status for the communication with the A-IoT device; an interference level measured by the second device; mobility status of the second device; or serving quality measured by the second device.

In another solution, a method of communication comprises: determining, at a first device, that an ambient Internet of things (A-IoT) device is to be changed from communicating with a second device to communicating with a third device; and determining a configuration associated with the change for communication between the third device and the A-IoT device.

In some embodiments, determining that the A-IoT device is to be changed from communicating with the second device to communicating with the third device comprises: in accordance with a determination that a set of conditions is satisfied, determining that the A-IoT device is to be changed from communicating with the second device to communicating with the third device. The set of conditions comprises at least one of the following: the change is indicated by an upper layer of the first device; an interference level of the second device is above a threshold level; quality of communication between the second device and the A-IoT device is below threshold communication quality; number of A-IoT devices served by the second device is above a threshold number; quality of a serving cell of the second device is below first threshold quality; quality of a serving cell of the second device is above second threshold quality; a handover command is received or a cell change is indicated to be performed for the second device; a location of the second device is changed; or a mobility status of the second device is changed.

In some embodiments, determining that the A-IoT device is to be changed from communicating with the second device to communicating with the third device comprises: receiving, from the second device, a request for the change; and determining that the A-IoT device is to be changed from communicating with the second device to communicating with the third device.

In some embodiments, determining the configuration associated with the change comprises: selecting, as the third device, a device available for the communication with the A-IoT device; and determining the configuration associated with the change comprising at least one of the following: a first configuration for the A-IoT device, a second configuration for the second device, or a third configuration for the third device.

In some embodiments, the method further comprises at least one of the following: transmitting, to the A-IoT device, a command comprising the first configuration; transmitting the second configuration to the second device; or transmitting the third configuration to the third device.

In some embodiments, the first device is the second device.

In another solution, a method of communication comprises: receiving, at an ambient Internet of things (A-IoT) device and from a first device, a command for A-IoT communication; and in accordance with a determination that information of the first device in the command matches a configuration of the A-IoT device, responsing to the command.

In some embodiments, the configuration comprises at least one of the following: information of a set of candidate devices; information of a set of activated candidate devices in the set of candidate devices; or a security configuration.

In some embodiments, responsing to the command comprises: in accordance with a determination that the information of the first device matches the information of a candidate device in the set of candidate devices, responsing to the command.

In some embodiments, responsing to the command comprises: in accordance with a determination that the candidate device is activated, responsing to the command.

In some embodiments, responsing to the command comprises: in accordance with a determination that the information of the first device matches the security configuration, responsing to the command.

In another solution, a method of communication comprises: receiving, at an ambient Internet of things (A-IoT) device, a command associated with a change of the A-IoT device from communicating with a second device to communicating with a third device; and updating, based on the command, a configuration associated with the change.

In some embodiments, the configuration associated with the change comprises at least one of the following: information of a set of candidate devices; information of a set of activated candidate devices in the set of candidate devices; or a security configuration.

In some embodiments, the configuration associated with the change comprises information of a set of candidate devices, and updating the configuration comprises: in accordance with a determination that the command is received from a candidate device or an activated candidate device in the set of candidate devices, updating the configuration associated with the change based on the command; or in accordance with a determination that the command is received from a candidate device or an activated candidate device in the set of candidate devices and that the third device is a further candidate device or an activated further candidate device in the set of candidate devices, updating the configuration associated with the change based on the command.

In another solution, a method of communication comprises: receiving, at an ambient Internet of things (A-IoT) device, a command for obtaining mobility information of the A-IoT device; and transmitting the mobility information of the A-IoT device.

In some embodiments, the mobility information comprises at least one of the following: information of a last connection of the A-IoT device; or a configuration associated with a change of the A-IoT device from communicating with a second device to communicating with a third device.

In some embodiments, the configuration associated with the change comprises at least one of the following: information of a set of candidate devices; information of a set of activated candidate devices in the set of candidate devices; or a security configuration.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 15. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A first device comprising:
a processor configured to cause the first device to:
determine that a second device fulfills a condition for communication with an ambient Internet of things (A-IoT) device; and
initiate the communication between the second device and the A-IoT device.

22. The first device of claim 21, wherein the first device is caused to determine that the second device fulfills the condition by:
obtaining, from the second device, information of the second device associated with the communication; and
determining, based on the information of the second device, that the second device fulfills the condition.

23. The first device of claim 22, wherein the information is associated with at least one of the following:
capability for the communication with the A-IoT device;
an authentication status for the communication with the A-IoT device;
an authorization status for the communication with the A-IoT device;
an interference level measured by the second device;
a mobility status of the second device; or
serving quality measured by the second device.

24. The first device of claim 22, wherein the first device is an access network device, and the second device is a terminal device.

25. The first device of claim 24, wherein the first device is caused to initiate the communication by:
transmitting, to the second device, an indication for initiating the communication.

26. The first device of claim 21, wherein the second device is the first device, and wherein the first device is further caused to:
receive, from a third device, information of the condition.

27. The first device of claim 26, wherein the first device is a terminal device, and the third device is an access network device.

28. The first device of claim 27, wherein the first device is further caused to:
transmit, to the third device, an indication that the first device fulfills the condition for the communication with the A-IoT device.

29. The first device of claim 26, wherein the first device and third device are terminal devices.

30. The first device of claim 29, wherein the first device is further caused to:
transmit, to the third device or to an access network device, an indication that the first device fulfills the condition for the communication with the A-IoT device.

31. The first device of claim 21, wherein the condition is associated with at least one of the following:
capability for the communication with the A-IoT device;
an authentication status for the communication with the A-IoT device;
an authorization status for the communication with the A-IoT device;
an interference level measured by the second device;
a mobility status of the second device; or
serving quality measured by the second device.

32. A first device comprising:
a processor configured to cause the first device to:
determine that an ambient Internet of things (A-IoT) device is to be changed from communicating with a second device to communicating with a third device; and
determine a configuration associated with the change for communication between the third device and the A-IoT device.

33. The first device of claim 32, wherein the first device is caused to determine that the A-IoT device is to be changed from communicating with the second device to communicating with the third device by:
in accordance with a determination that a set of conditions is satisfied, determining that the A-IoT device is to be changed from communicating with the second device to communicating with the third device, the set of conditions comprising at least one of the following:
the change is indicated by an upper layer of the first device;
an interference level of the second device is above a threshold level;
quality of communication between the second device and the A-IoT device is below threshold communication quality;
number of A-IoT devices served by the second device is above a threshold number;
quality of a serving cell of the second device is below first threshold quality;
quality of a serving cell of the second device is above second threshold quality;
a handover command is received or a cell change is indicated to be performed for the second device;
a location of the second device is changed; or
a mobility status of the second device is changed.

34. The first device of claim 32, wherein the first device is caused to determine that the A-IoT device is to be changed from communicating with the second device to communicating with the third device by:
receiving, from the second device, a request for the change; and
determining that the A-IoT device is to be changed from communicating with the second device to communicating with the third device.

35. The first device of claim 33, wherein the first device is caused to determine the configuration associated with the change by:
selecting, as the third device, a device available for the communication with the A-IoT device; and
determining the configuration associated with the change comprising at least one of the following:
a first configuration for the A-IoT device,
a second configuration for the second device, or
a third configuration for the third device.

36. The first device of claim 35, wherein the first device is further caused to at least one of the following:
transmit, to the A-IoT device, a command comprising the first configuration;
transmit the second configuration to the second device; or
transmit the third configuration to the third device.

37. The first device of claim 32, wherein the first device is the second device.

38. An ambient Internet of things (A-IoT) device comprising:
a processor configured to cause the A-IoT device to:
receive a command for obtaining mobility information of the A-IoT device; and
transmit the mobility information of the A-IoT device.

39. The A-IoT device of claim 38, wherein the mobility information comprises at least one of the following:
information of a last connection of the A-IoT device; or
a configuration associated with a change of the A-IoT device from communicating with a second device to communicating with a third device.

40. A method, performed by a device, the method comprising:
receiving information for an A-IoT device; and
determining a reader to be a last connected reader, in a case where the information comprises a set of candidate devices for the A-IoT device.
